(19) United States
(12) Patent Application Publication
(10) Pub. No.: US 2016/0261947 A1
(43) Pub. Date: Sep. 8, 2016

(54) Wire Storage

(71) Applicants: Masanori ITO, Toyama (JP); Zhongjun HU, Shanghai (CN)

(72) Inventors: Masanori Ito, Toyama (JP); Zhongjun Hu, Shanghai (CN); Shiro Sugimoto, Toyama (JP)

(21) Appl. No.: 14/902,758

(22) PCT Filed: Jul. 4, 2014
(86) PCT No.: PCT/CN2014/081693

§ 371 Date: Mar. 8, 2016

(30) Foreign Application Priority Data
Jul. 4, 2013 (CN) 201310279466.5

(51) Int. Cl. H04R 1/10; A45C 13/10

(52) U.S. Cl. CPC H04R 1/1033; H04R 1/1016; A45C 13/103

(57) ABSTRACT

The present invention discloses a wire storage. The wires are stored within an independent channel which, by means of a zipper, can be removably winded on to the main body, thus storing the wires and effectively protecting the same; when the channel is connected by means of the zipper to the main body, the channel becomes a part of the storage. A further storage space is formed within the main body of the storage, or a new storage space is formed when the zipper is closed, the spaces are able to be adapted for use with other electronic products and thus enhancing the utility of the product. The present invention greatly decreases the possibility of wires being damaged or broken by external forces, is suitable for a variety of usage scenarios, and is aesthetically pleasing and convenient to use.

This application is a U.S. National Phase of PCT/CN2014/081693, filed Jul. 4, 2014, which claims the benefit of priority to Chinese Patent Application No. CN 201310279466.5, filed on Jul. 4, 2013, the entire content of which is incorporated herein by reference.

### BACKGROUND OF THE INVENTION

1. Field of the Invention

The present invention relates to a storage, and more particularly, relates to a wire storage.

2. Description of the Related Art

Structures with long wires, such as the wire in a transformer, in a charger, or in a headphone, are likely to appear in electronic product design.

Headphone is an essential accessory to an electronic product, which is configured for providing fine sound transfer which is unlikely to be influenced by the surroundings. The wire of a headphone is generally long and thin. Therefore, the wire is likely to be winded or be damaged due to pulls by external forces during the use of the headphone, especially when used in strenuous exercises. Moreover, the wires of headphones are also difficult to store after using. At present, the ways of storing headphone wire is single. The wire is often winded onto a winder, and the body of the wire is exposed in the air. There is a high possibility for the wires to be broken and therefore it is not convenient to use.

Above mentioned problems also appear in other wire structures of electronic products, such as transformers, chargers and so on.

### SUMMARY OF THE INVENTION

To solve the above technical solution, the present invention discloses a wire storage, which greatly decreases the possibility of wires being damaged or broken by external forces, and is suitable for a variety of usage scenarios, and is aesthetically pleasing and convenient to use.

The present invention is implemented by following technical solutions:

One object of the invention is direct to a wire storage, comprising a bottom, a channel in which a wire is arranged; the channel being connected to the bottom on one end, and being able to be closed spirally by a connector to a bag-shaped main body; preferably, a stopping sleeve is arranged on the top of the channel to prevent the wires from slipping into the channel; more preferably, a fixing device is configured on the bottom of the channel to fix one end of the wire.

The above wire storage, wherein the connector is a zipper comprising a pair of zipper bands along which zipper dentitions are configured on opposite side edges, the zipper also includes a slider which can be mounted by sliding along the zipper dentition, and the sliding makes the zipper dentition engaged or divided.

The above wire storage, wherein the zipper bands include a first zipper band and a second zipper band, both have the same length, the first zipper band passes from the joint where the channel and the bottom are jointed together, through the upper edge of the bottom, to the other end of the channel; the second zipper band passes from the joint where the channel and the bottom are jointed together to the other end of the channel directly.

The above wire storage, wherein the zipper bands are attached on one side edge of the channel by flat sewed stitch respectively, or attached on upper edge of the bottom by the flat sewed stitch.

Another object of the invention is direct to a wire storage, wherein includes a main body and a channel in which a wire is arranged; the channel being connected to the main body on one end, the channel being able to be closed spirally by a connector, and being able to be spirally winded onto the main body after the channel is closed; the main body being bag-shaped.

The above wire storage, wherein the connector is a zipper comprising a pair of zipper bands along which zipper dentitions are configured on opposite side edges, the zipper also includes a slider which can be mounted by sliding along the zipper dentition, and the sliding makes the zipper dentition engaged or divided.

The above wire storage, wherein the zipper bands include a first zipper band and a second zipper band, both have the same length, the first zipper band is spirally winded onto the main body, one end of the second zipper band is connected to the first zipper band.

The above wire storage, wherein the first zipper band is winded onto the main body upward from the bottom of the main body.

The above wire storage, wherein the top of the main body has an open-close cover.

The above wire storage, wherein the zipper bands are attached on one side edge of the channel by flat sewed stitch respectively, or attached on the main body.

The benefit effects of the invention to the prior art are:

The wires are stored within an independent channel which, by means of a zipper, can be removably winded on to the main body, thus storing the wires and effectively protecting the same; when the channel is connected by means of the zipper to the main body, the channel becomes a part of the storage. A further storage space is provided within the main body of the storage, or a new storage space is formed when the zipper is closed, such space is able to be adapted for use with other electronic products and thus enhancing the utility of the product.

### BRIEF DESCRIPTIONS OF THE DRAWINGS

The accompanying drawings, together with the specification, illustrate exemplary embodiments of the present disclosure, and, together with the description, serve to explain the principles of the present invention.

FIG. 1 is a structure schematic diagram of the wire storage after the zipper is closed according to Embodiment 1 of the present invention;

FIG. 2 is a structure schematic diagram of the wire storage after the zipper is opened according to Embodiment 1 of the present invention;

FIG. 3 is a section view of the channel having zipper bands and zipper dentition on both sides of the channel according to Embodiment 1 of the present invention;

FIG. 4 is a structure schematic diagram of the wire storage after the zipper is opened according to Embodiment 2 of the present invention;

FIG. 5 is a section view of the channel having zipper bands and zipper dentition on one side of the channel according to Embodiment 2 of the present invention.

### DETAILED DESCRIPTION

The following description is combined by the drawings and the preferred embodiments. In the embodiments of the invention, the description is based on headphone wires which are represented as the wires.

### Embodiment 1

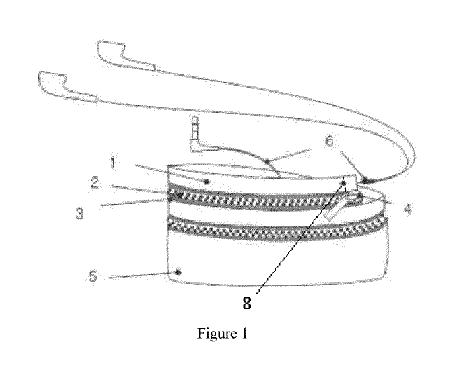

Referring to FIG. 1, the invention provides a wire storage, especially a headphone wire storage, wherein the wire storage includes an bottom 5 and an channel 1 in which the headphone wire 6 is arranged. One end of the channel 1 is connected to the bottom 5. The channel 1 can be closed spirally by a connector to forms a bag-shaped main body.

In a preferred embodiment, the connector is a zipper comprising a pair of zipper bands 3 along which zipper dentitions 2 are configured on the opposite side edges. The zipper also includes a slider 4 which can be mounted by sliding along the zipper dentitions 2, and the sliding makes the zipper dentitions 2 engaged or divided. The zipper dentitions 2 are not limited to only metal, but also synthetic resin.

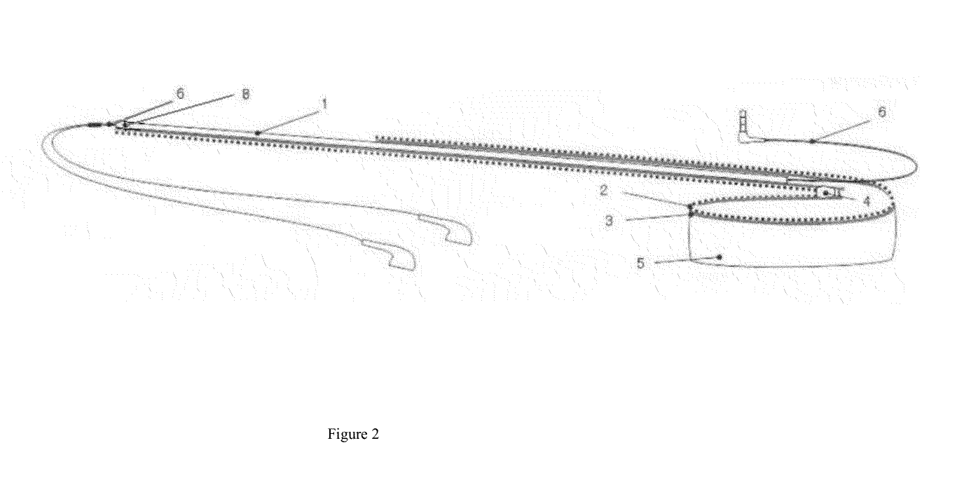

Referring to FIG. 2, the zipper bands 3 include a first zipper band and a second zipper band, both have the same length. The first zipper band passes from the joint where the channel 1 and the bottom 5 are jointed together, through the upper edge of the bottom 5, to the other end of the channel 1. The second zipper band passes from the joint where the channel 1 and the bottom 5 are jointed together to the other end of the channel 1 directly. Due to the same length, it can be seen from FIG. 1 that most upper end of the channel 1 is a smooth opening when the first zipper band and the second zipper band are fully zipped to be closed, the top end of the channel 1 is a smooth opening, so such structure is designed after the consideration of aesthetics of the whole structure after the bag-shaped main body is formed. The most parts of the headphone can be stored in the channel 1 except for the plug-end and earplug-ends. Therefore, the wires can be stored and protected effectively. The plug-end is stored in advance in the bottom 5 so that the earplug-ends can be entirely placed into the main body after the main body is formed. Of course, other subjects can be stored in the main body as well.

Referring to FIG. 3, two sides of the channel 1 have the zipper bands 3 respectively, one side of the zipper bands 3 is extended into the side of the channel 1 and is connected to the channel 1 tightly.

The interlocking fastener bands 3 are attached on one side edge of the channel 1 by the flat sewed stitch respectively, or attached on upper edge of the accommodating bottom 5 by the flat sewed stitch. The orderly flat sewed stitch provide the tightly connection without impacting the entire beauty.

The zipper bands 3 are attached on one side edge of the channel 1 by flat sewed stitch respectively, or attached on upper edge of the bottom 5 by the flat sewed stitch. A reliable connection can be achieved in the condition that overall aesthetics will not be damaged due to the orderly flat sewed stitch.

Furthermore, the zipper bands 3 are made of nylon, which have a certain mechanical strength, fire resistance and water resistance property. The channel 1 is made of the material which has good flexibility and abrasive resistance property, such as leather, to be adapted in many situations.

Referring to FIGS. 1-2, preferably, a stopping sleeve 8 is configured on the top of the channel 1 to prevent the wire, that is headphone wire 6, from slipping into the channel entirely; the inner diameter of the channel 1 is shortened at the position where the stopping sleeve 8 placed, so that the instance that the earplug slipping into the channel 1 is prevented.

Preferably, a fixing device (not shown) is configured on the bottom 5 to fix one end of the wire, that is, headphone wire 6, so that the ends of the wire are stored and are not influenced by the surroundings.

In this way, this embodiment has the following effect based on the implements of above FIG. 1 and FIG. 2:

The headphone wires are stored within an independent channel which, by means of an interlocking fastener, can be removably winded onto the main body, thereby storing the wires and effectively protecting the same; when the channel is connected by means of the zipper to the main body, the channel becomes a part of the storage. A new storage space is formed in the main body when the zipper is closed, and the new storage space is able to be adapted for use with other electronic products and thus enhancing the utility of the product.

### Embodiment 2

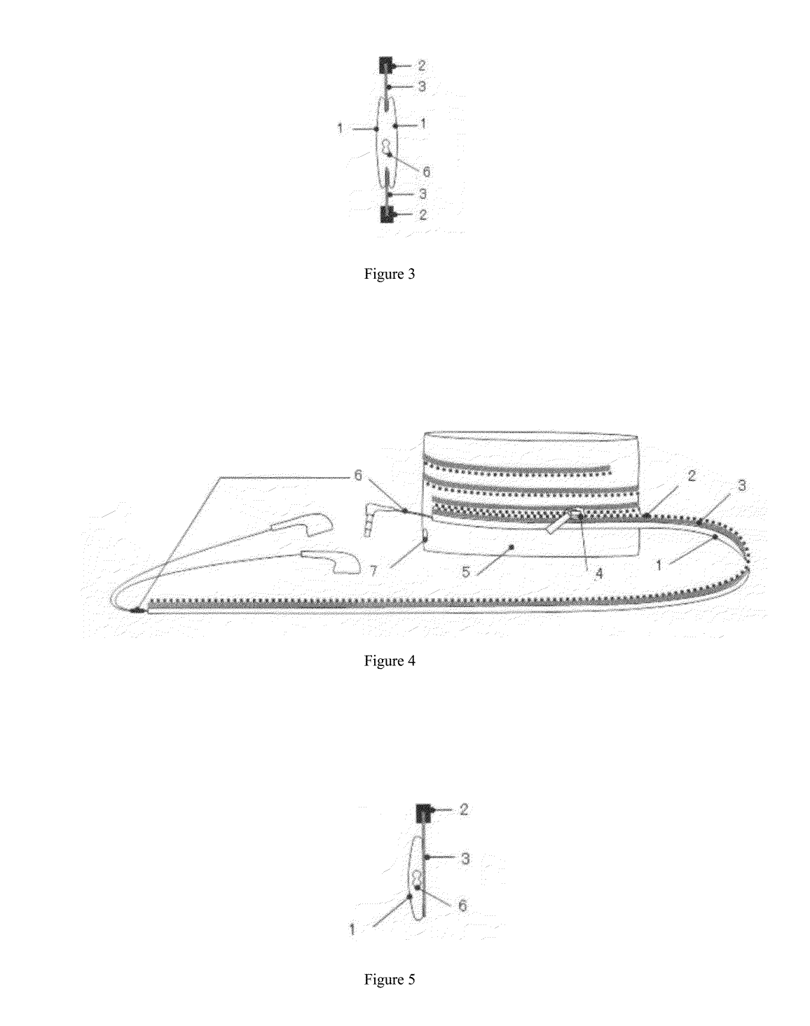

Referring to FIG. 4, the invention provides a wire storage, the headphone includes a headphone wire 6, the wire storage includes a bottom 5 and a channel 1 in which the headphone wire 6 is arranged. The channel 1 is connected to the bottom 5 on one end. The channel 1 can be closed spirally by a connector, and can be winded onto the main body 1 after the channel 1 is closed; the main body 1 is bag-shaped.

The connector is a zipper comprising a pair of zipper bands 3 along which zipper dentitions 2 are configured on the opposite side edge. The zipper also includes a slider 4 which can be mounted by sliding along the zipper dentitions 2, and the sliding makes the zipper dentitions 2 engaged or divided. The zipper dentition 2 is limited to not metal, but also synthetic resin.

The zipper bands 3 include a first zipper band and a second zipper band, both have the same length. The first zipper band is winded spirally on to the main body 5, one end of the second zipper band is connected to the first zipper band. The first zipper band is winded upward from the bottom 5 of the main body, the way of winding from bottom to top is common in use, and the way of winding from top to bottom can also be used.

Furthermore, the top of the main body 5 has an open-close cover (not shown), the cover can shield the top of the main body 5 by using the nylon fastener tape and so on, to prevent the internals from falling out of the main body.

Referring to FIG. 4, a port 7 is configured on the bottom of the main body 5 at one side of the beginning of the channel 1, the metal part of the headphone plug is extended into the port 7 to prevent from the impact of the environment.

The zipper bands 3 are attached on one side edge of the channel 1 by the flat sewed stitch respectively, or attached the bottom 5 by the flat sewed stitch. The orderly flat sewed stitch provide the tightly connection without impacting the entire beauty.

Furthermore, the zipper bands 3 are made of nylon, which have a certain mechanical strength, fire resistance and water resistance property. The channel 1 is made of the material which has good flexibility and abrasive resistance property, such as leather, to be adapted in many situations.

Referring to FIG. 5, in the embodiment, the channel 1 has a zipper band 3 on only one side, the zipper band 3 passes through the whole channel 1 and connects to it tightly. One end of the zipper band 3 is extended out of the channel 1 and is connected to the zipper dentition 2.

In this way, this embodiment has the following effect based on the implement shown in FIG. 4:

The headphone wires are stored within an independent channel which, by means of the zipper, can be removably winded onto the main body, thus storing the wires and effectively protecting the same; a further storage space is provided within the main body of the storage, the further storage space is able to be adapted for use with other electronic products and thus enhancing the utility of the product.

The description listed above is the embodiments of the invention. The invention is not limited in the above embodiments, and it is only the example. It should be understood for the skilled in the art that any changes and modifications are in the scope of the invention. Such changes and modifications can be made without departing from the spirit and scope of the present disclosure and are in the scope of the invention.

What is claimed is:

1. A wire storage, comprising a bottom, a channel in which a wire is arranged; the channel being connected to the bottom on one end, and being able to be closed spirally by a connector to a bag-shaped main body; preferably, a stopping sleeve is arranged on the top of the channel to prevent the wires from slipping into the channel; more preferably, a fixing device is configured on the bottom of the channel to fix one end of the wire.

2. The wire storage as disclosed in claim 1, wherein the connector is a zipper comprising a pair of zipper bands along which zipper dentitions are configured on opposite side edges, the zipper also includes a slider which can be mounted by sliding along the zipper dentition, and the sliding makes the zipper dentition engaged or divided.

3. The wire storage as disclosed in claim 2, wherein the zipper bands include a first zipper band and a second zipper band, both have the same length, the first zipper band passes from the joint where the channel and the bottom are jointed together, through the upper edge of the bottom, to the other end of the channel; the second zipper band passes from the joint where the channel and the bottom are jointed together to the other end of the channel directly.

4. The wire storage as disclosed in claim 2, wherein the zipper bands are attached on one side edge of the channel by flat sewed stitch respectively, or attached on upper edge of the bottom by the flat sewed stitch.

5. The wire storage as disclosed in claim 3, wherein the zipper bands are attached on one side edge of the channel by flat sewed stitch respectively, or attached on upper edge of the bottom by the flat sewed stitch.

6. A wire storage, wherein includes a main body and a channel in which a wire is arranged; the channel being connected to the main body on one end, the channel being able to be closed spirally by a connector, and being able to be spirally winded onto the main body after the channel is closed; the main body being bag-shaped.

7. The wire storage as disclosed in claim 6, wherein the connector is a zipper comprising a pair of zipper bands along which zipper dentitions are configured on opposite side edges, the zipper also includes a slider which can be mounted by sliding along the zipper dentition, and the sliding makes the zipper dentition engaged or divided.

8. The wire storage as disclosed in claim 7, wherein the zipper bands include a first zipper band and a second zipper band, both have the same length, the first zipper band is spirally winded onto the main body, one end of the second zipper band is connected to the first zipper band.

9. The wire storage as disclosed in claim 8, wherein the first zipper band is winded onto the main body upward from the bottom of the main body.

10. The wire storage as disclosed in claim 8, wherein the top of the main body has an open-close cover.

11. The wire storage as disclosed in claim 7, wherein the zipper bands are attached on one side edge of the channel by flat sewed stitch respectively, or attached on the main body.

12. The wire storage as disclosed in claim 8, wherein the zipper bands are attached on one side edge of the channel by flat sewed stitch respectively, or attached on the main body.

13. The wire storage as disclosed in claim 9, wherein the zipper bands are attached on one side edge of the channel by flat sewed stitch respectively, or attached on the main body.
